(19) United States
(12) Patent Application Publication
(10) Pub. No.: US 2010/0270794 A1
(43) Pub. Date: Oct. 28, 2010

(54) Service Adapter Kit

(76) Inventor: Peter J. Lambe, Anaheim, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/626,387

(22) Filed: Nov. 25, 2009

Related U.S. Application Data
(60) Provisional application No. 61/118,307, filed on Nov. 26, 2008.

(30) Foreign Application Priority Data
Nov. 25, 2009 (US) PCT/US2009/055952

(51) Int. Cl. F01N 13/08; F16L 23/18

(52) U.S. Cl. 285/364

(57) ABSTRACT

An emission control adapter kit comprising an L-shaped flange member and a split ring clamped around and directly engaging the L-shaped member.

### CROSS REFERENCE TO RELATED APPLICATIONS

This application claims priority to U.S. provisional patent application Ser. No. 61/118,307, filed on Nov. 26, 2008, which is fully incorporated herein by reference.

### BRIEF SUMMARY OF THE INVENTION

An emission control adapter kit comprising an L-shaped flange member and a split ring clamped around and directly engaging the L-shaped member.

### BRIEF DESCRIPTION OF THE DRAWINGS

The figures show old and new flanges.

### DETAILED DESCRIPTION OF THE INVENTION

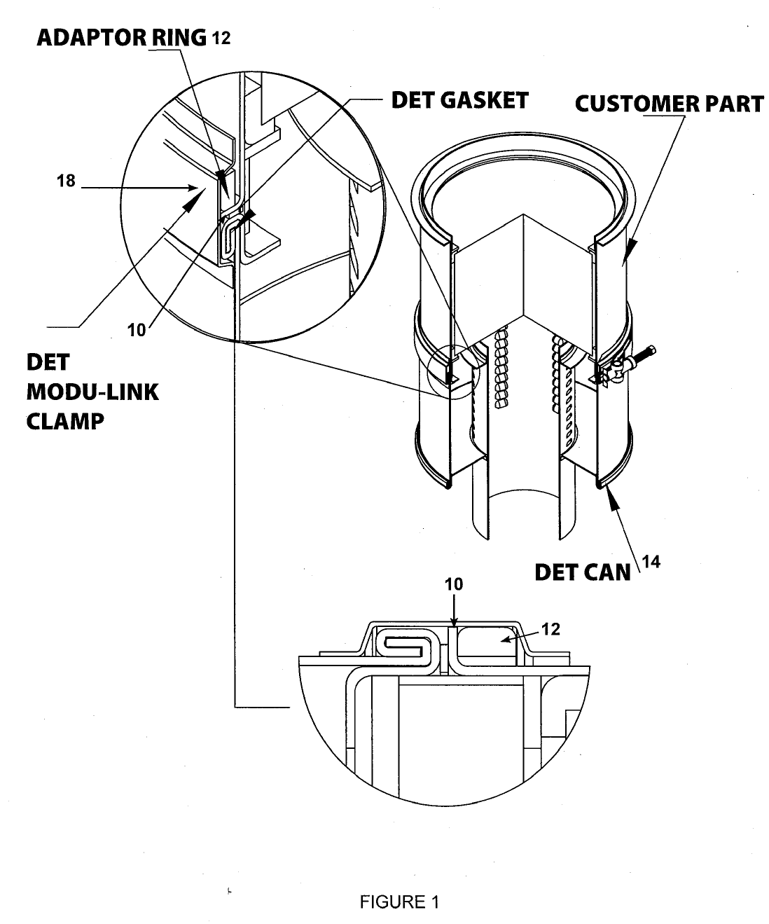

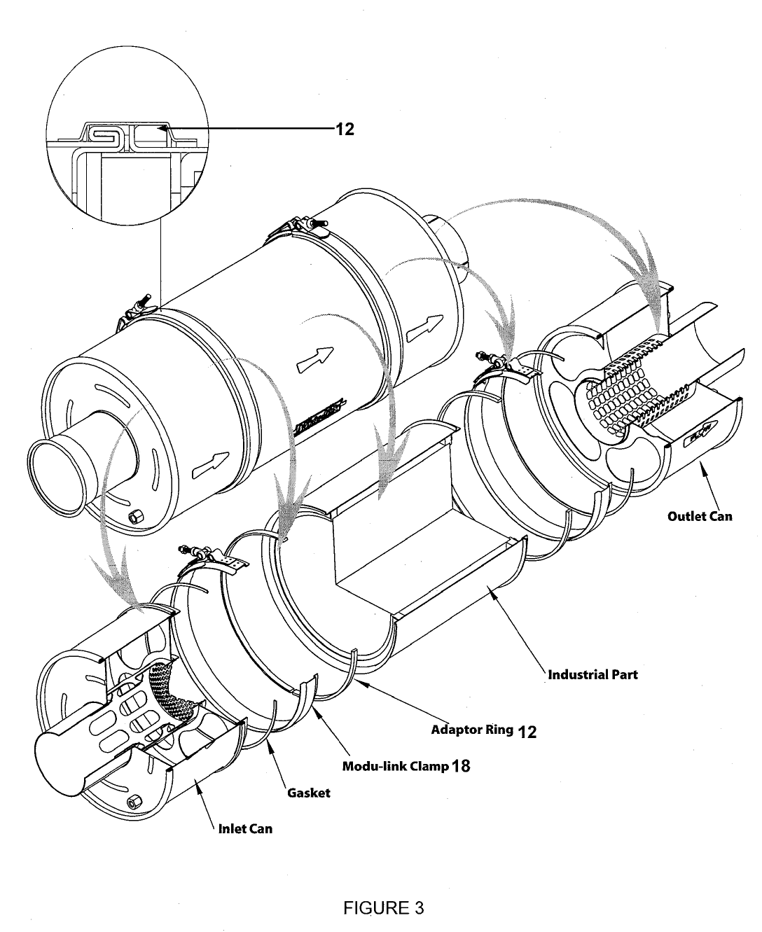

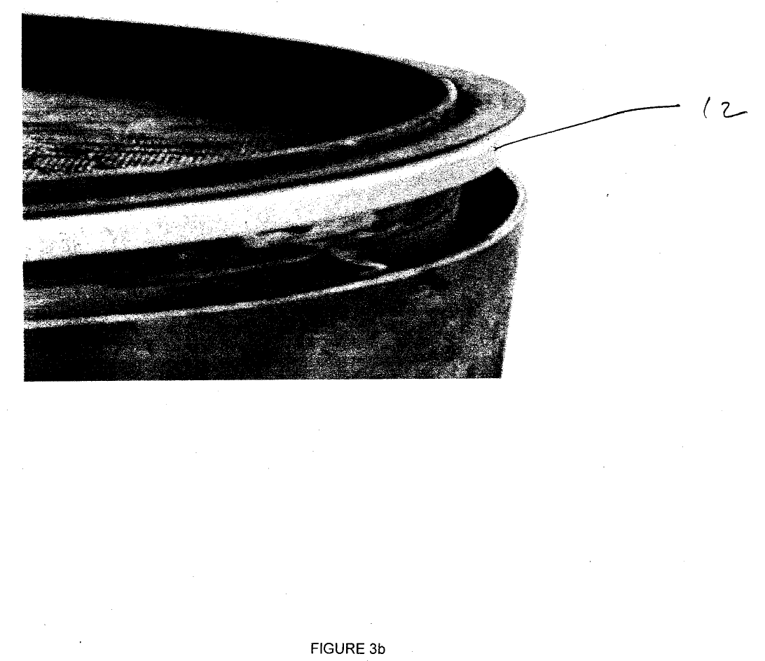

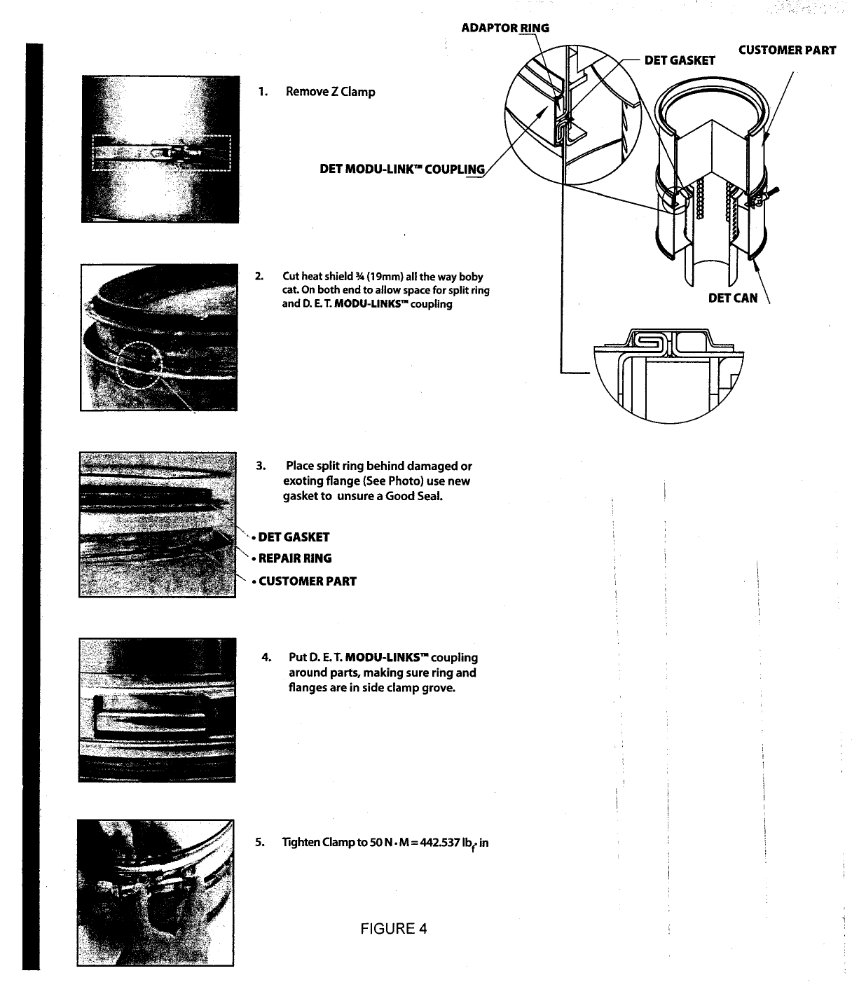

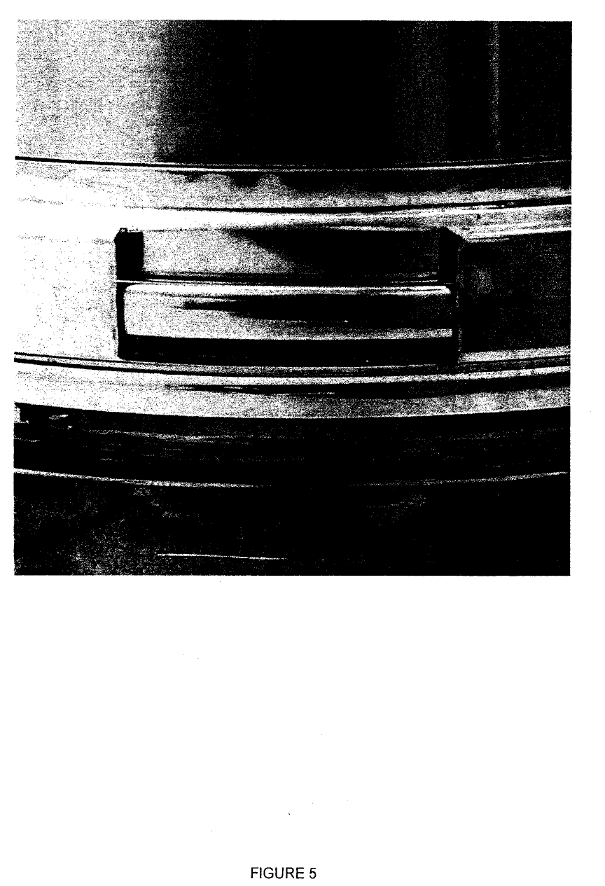

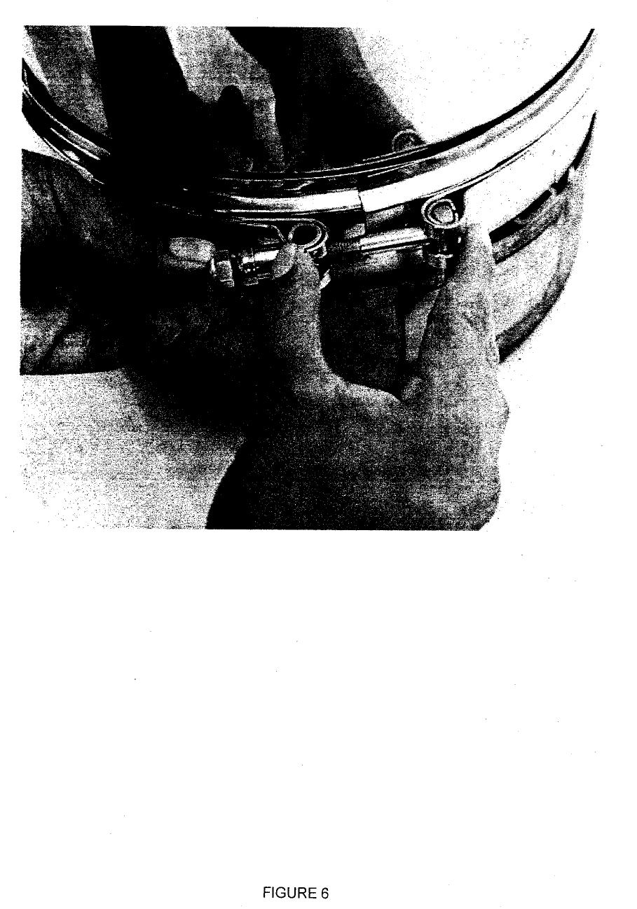

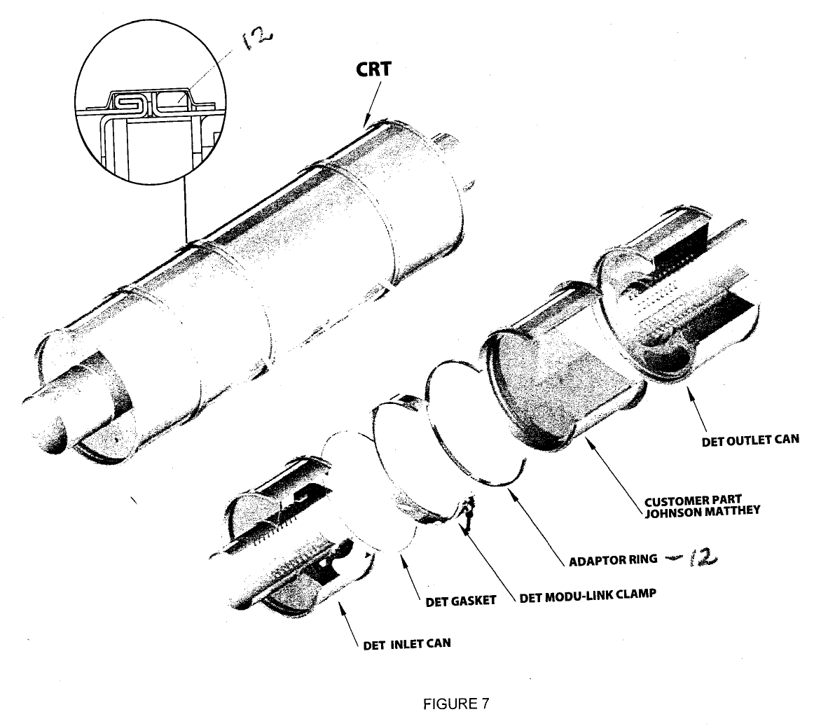

Some exhaust systems use L-shaped end flanges which are mated and held together by a clamp. These L-shaped flanges unfortunately break or tear because of the heavy weight of the exhaust system and vibration. Such a flange is shown at 10 in FIG. 1 and FIG. 3.

Applicant has devised a simple and reliable fix for this problem by providing an adapter split ring 12 clamped around the L-shaped member as best seen in FIG. 1, and FIG. 3. A diesel emission technologies can 14 as seen in FIGS. 1 and 3 can be mated with the old customer part 16, and the two held together by a Modu-Link clamp 18 after installation of the adapter ring 12.

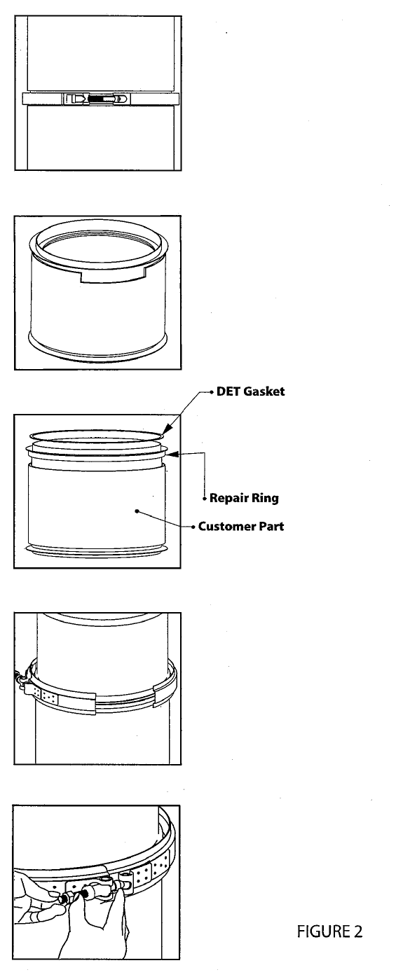

FIGS. 2-3 further illustrate a construction.

The present product allows one to offer a full comprehensive emission control adaptor kit which gives features of functionality.

The ability to be able to exchange, replace, repair and interchange existing products with the patented Modu-link Canned technology.

This product allows the customer to minimize inventory, reduce numbers of potential vendors, it also allows availability for products to be cleaned and serviced.

It maximizes uses of one style of clamp but ensures that competitors cannot connect to the Modu-link construction.

This system allows exchangeability across not only technologies but over canning construction with minimum cost but also be used to repair any signs of initial damage to infield applications, therefore, extending product life.

This is a fix for existing damaged flanges (connecting faces) which means a customer does not have to replace the whole unit, only a component part of other technology and exhaust canners products.

No other company does this but if they ever did they could not use a weld free seam. Ours is a weld free solution, unique and unrivalled, it gives more axial support and creates a stronger joint.

The objective is to patent the following:

1. The adaptor kit

2. We also need to protect and ensure the ring design.

What is claimed is:

1. An emission control adapter kit comprising an L-shaped flange member and a split ring clamped around and directly engaging the L-shaped member.

2. An adapter kit as in claim 1 further including a modu-link clamp covering the L-shaped member and split ring.
